(19) United States
(12) Patent Application Publication
(10) Pub. No.: US 2021/0041608 A1
(43) Pub. Date: Feb. 11, 2021

(54) DIELECTRIC MULTILAYER FILM MIRROR

(71) Applicant: Shimadzu Corporation, Kyoto (JP)

(72) Inventors: Takuya KIMOTO, Kyoto-shi, Kyoto (JP); Yasuyuki FURUKAWA, Kyoto-shi, Kyoto (JP)

(73) Assignee: Shimadzu Corporation, Kyoto (JP)

(21) Appl. No.: 16/976,074

(22) PCT Filed: Feb. 27, 2018
(86) PCT No.: PCT/JP2018/007252

§ 371 Date: Aug. 26, 2020

(51) Int. Cl. G02B 5/08; G02B 1/14

(52) U.S. Cl. CPC G02B 5/0833; G02B 5/0891; G02B 1/14

(57) ABSTRACT

Provided is a dielectric multilayer film mirror including: a substrate; a first multilayer film structure formed on the substrate and including alternately stacked layers of a first low refractive index material having a refractive index equal to or lower than a refractive index of a second low refractive index material and a first high refractive index material having a refractive index higher than a refractive index of a second high refractive index material; and a second multilayer film structure formed on the first multilayer film structure and including alternately stacked layers of the second low refractive index material and the second high refractive index material, the second high refractive index material having a refractive index higher than a refractive index of the second low refractive index material and having an extinction coefficient lower than an extinction coefficient of the first high refractive index material.

### TECHNICAL FIELD

The present invention relates to a dielectric multilayer film mirror used for reflecting ultraviolet light.

### BACKGROUND ART

Ultraviolet light is used in a wide range of fields such as a semiconductor manufacturing process for which an accuracy measurement or a highly precise processing is required. In order to increase precision or efficiency of a measuring device or a processing device, it is effective to increase an intensity of ultraviolet light. A dielectric multilayer film mirror is used in the measuring device or processing device using ultraviolet light in order to minimize the loss of the ultraviolet light emitted from a light source.

FIG. 1 shows an example of a dielectric multilayer film mirror used in the related art.

A dielectric multilayer film mirror 100 includes alternately stacked layers of two kinds of materials having different refractive indices (a low refractive index material layer 122 and a high refractive index material layer 121) on a substrate 110. For example, silicon oxide SiO₂ having the refractive index of 1.49 (the value at the wavelength of 250 nm, hereinafter, denoted as “@250 nm”) is used for the low refractive index material layer 122. For the high refractive index material layer 121, for example, hafnium oxide HfO₂ having a refractive index of 2.18 (@250 nm) is used. In the dielectric multilayer film mirror 100, as the difference in refractive index between the low refractive index material layer 122 and the high refractive index material layer 121 is larger, the reflectance at the interface between the low refractive index material layer 122 and the high refractive index material layer 121 is greater. Silicon oxide SiO₂, which has an excellent environment resistance, is used for the outermost layer (in FIG. 1, the low refractive index material layer 123) of the dielectric multilayer film mirror 100, and the layer is formed to have the thickness at which a reflection efficiency is the highest (typically, so that the optical thickness is half a target wavelength). When used for a laser, the high refractive index material is protected from an air breakdown by the laser.

### CITATION LIST

### Patent Literature

Patent Literature 1: JP 2007-133325 A

### SUMMARY OF INVENTION

### Technical Problem

In the dielectric multilayer film mirror 100, as the number of stacked dielectric layers is increased, the number of interfaces between the low refractive index material layers 122 and the high refractive index material layers 121 is increased, and thus the number of times of reflection of ultraviolet light is increased by the number of interfaces. However, since light reflected at an interface positioned near the substrate 110 (that is, in the deep position) passes through many dielectric layers until the light reaches the surface of the mirror, a part of the reflected light is absorbed in the dielectric layers.

FIGS. 2A and 2B show reflectance characteristics of a dielectric multilayer film mirror including alternately stacked layers of silicon oxide SiO₂ and hafnium oxide HfO₂, when the number of stacked layers is 10 (5 pairs), 20 (10 pairs), 30 (15 pairs), and 40 (20 pairs). FIG. 2B is a partially enlarged view of FIG. 2A. In a case where the dielectric multilayer film mirror includes alternately stacked layers of silicon oxide SiO₂ and hafnium oxide HfO₂, and the number of stacked layers is increased up to about 30 (15 pairs), the reflectance increases to 99.67%, but does not increase any more when the number of stacked layers is more than 30.

An object to be achieved by the present invention is to provide a dielectric multilayer film mirror capable of obtaining a higher reflectance in an ultraviolet region than in the related art.

### Solution to Problem

Since, in a dielectric multilayer film mirror including alternately stacked layers of silicon oxide SiO₂ and hafnium oxide HfO₂, the reflectance cannot exceed the upper limit (99.67%) even when the number of stacked layers is increased, the present inventors have considered that it is necessary to develop a dielectric multilayer film mirror having a new structure in order to increase the reflectance equal to or higher than the upper limit of the reflectance, and thus the present inventors have examined various materials and configurations. As a result, the present inventors have considered that light absorption in a high refractive index material layer can be reduced by replacing a high refractive index material disposed near a surface where the amount of incident light is large with aluminum oxide Al₂O₃ having an extinction coefficient lower than that of hafnium oxide HfO₂ used in the related art, thereby achieving the present invention. Here, the dielectric multilayer film mirror including alternately stacked layers of silicon oxide SiO₂ and hafnium oxide HfO₂ has been described as the related art by way of example; however, even in a case where another high refractive index material and another low refractive index material are used in combination, it is possible to apply the same technical idea as described above.

That is, a dielectric multilayer film mirror according to the present invention aimed at solving the previously described problem includes:

a) a substrate;

b) a first multilayer film structure formed on the substrate including alternately stacked layers of a first low refractive index material and a first high refractive index material, the first low refractive index material having a refractive index equal to or lower than a refractive index of a second low refractive index material, and the first high refractive index material having a refractive index higher than refractive indices of the first low refractive index material and a second high refractive index material; and

c) a second multilayer film structure formed on the first multilayer film structure including alternately stacked layers of the second low refractive index material and the second high refractive index material, the second high refractive index material having a refractive index higher than a refractive index of the second low refractive index material and having an extinction coefficient lower than an extinction coefficient of the first high refractive index material.

The first low refractive index material and the second low refractive index material may be different from each other or may be the same as each other. For example, silicon oxide can be preferably used as the first low refractive index material and the second low refractive index material.

For example, hafnium oxide and aluminum oxide can be preferably used as the first high refractive index material and the second high refractive index material, respectively.

In a dielectric multilayer film mirror, larger amount of light is reflected at a location closer to the surface. Since the second multilayer film structure is disposed near the surface of the dielectric multilayer film mirror according to the present invention, the second multilayer film structure including alternately stacked layers of the second high refractive index material (for example, aluminum oxide Al₂O₃) having the extinction coefficient lower than the extinction coefficient of the first high refractive index material and the second low refractive index material (for example, silicon oxide SiO₂), the loss of light due to light absorption in the vicinity of the surface of the dielectric multilayer film mirror is reduced as compared to the related art. The light passed through the second multilayer film structure is highly efficiently reflected at an interface in the first multilayer film structure including alternately stacked layers of the first high refractive index material (for example, hafnium oxide HfO₂) and the first low refractive index material (for example, silicon oxide SiO₂), the first high refractive index material being a material having a refractive index higher than a refractive index of the second high refractive index material (for example, aluminum oxide Al₂O₃). As described above, in the dielectric multilayer film mirror according to the present invention, since the loss of light due to the light absorption in the vicinity of the surface of the dielectric multilayer film mirror is suppressed as compared to a conventional dielectric multilayer film mirror, a reflectance higher than a reflectance of the conventional dielectric multilayer film mirror can be obtained. Although details about the number of stacked layers and the like will be described below, when the dielectric multilayer film mirror produced by the present inventors is used, it is possible to reflect 99.82% of ultraviolet light of 250 nm wavelength.

### Advantageous Effects of Invention

When the dielectric multilayer film mirror according to the present invention is used, a larger light reflectance is obtained as compared to the related art.

### BRIEF DESCRIPTION OF DRAWINGS

FIG. 1 is a view showing a configuration of a conventional dielectric multilayer film mirror.

FIGS. 2A-2B are graphs showing a relationship between a reflectance and the number of stacked layers in a conventional dielectric multilayer film mirror including alternately stacked layers of silicon oxide and hafnium oxide.

FIGS. 3A-3B are graphs showing a relationship between a reflectance and the number of stacked layers in a conventional dielectric multilayer film mirror including alternately stacked layers of silicon oxide and aluminum oxide.

FIG. 4 is a view describing a reflectance in the vicinity of a surface of a dielectric multilayer film mirror including alternately stacked layers of silicon oxide and aluminum oxide.

FIG. 5 is a view showing a structure of a dielectric multilayer film mirror of one embodiment according to the present invention.

FIGS. 6A-6B are graphs showing reflectance characteristics of the dielectric multilayer film mirror of the present embodiment.

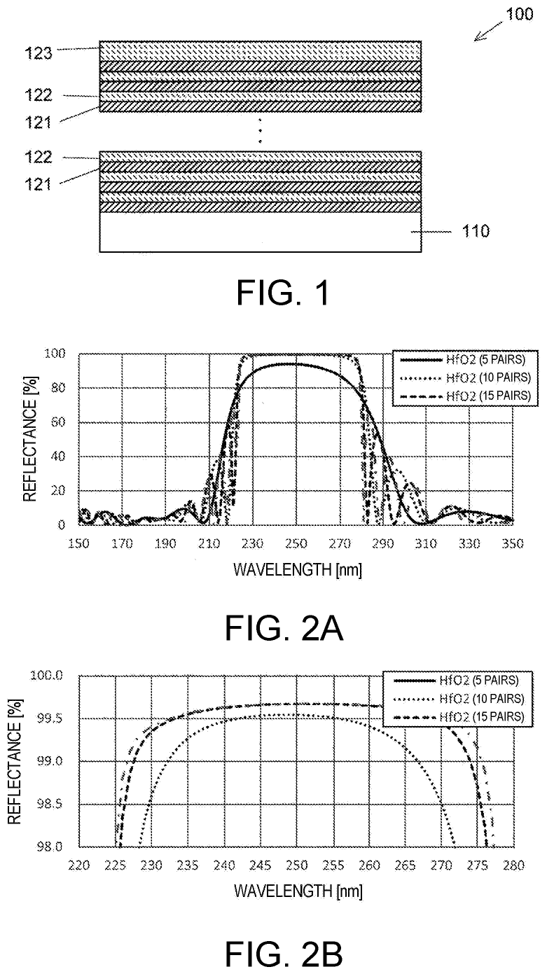

### DESCRIPTION OF EMBODIMENTS

As described above, since, in a dielectric multilayer film mirror including alternately stacked layers of silicon oxide SiO₂ and hafnium oxide HfO₂, the reflectance cannot exceed the upper limit (99.67%) even when the number of stacked layers is increased, the present inventors have considered that it is necessary to develop a dielectric multilayer film mirror having a new structure in order to increase the reflectance equal to or higher than the upper limit of the reflectance, and thus the present inventors have examined various materials and configurations. Before describing a specific embodiment of the dielectric multilayer film mirror according to the present invention, the examined contents will be described.

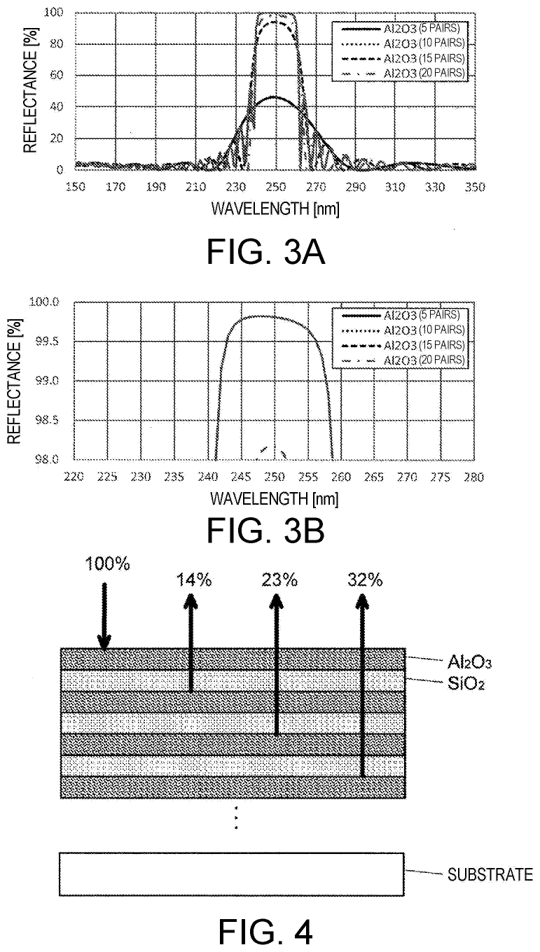

The present inventors have considered that aluminum oxide Al₂O₃ that is a material having an extinction coefficient lower than that of hafnium oxide HfO₂ is used as a high refractive index material in order to obtain a reflectance higher than that of a conventional dielectric multilayer film mirror. Then, the present inventors have investigated a relationship between the number of stacked layers and a reflectance, in a dielectric multilayer film mirror including alternately stacked layers of aluminum oxide Al₂O₃ and silicon oxide SiO₂. The results are shown in FIG. 3A. In addition, FIG. 3B is a partially enlarged view of the vicinity of a central wavelength (250 nm) of ultraviolet light to be reflected by the dielectric multilayer film mirror.

Even in a case where aluminum oxide Al₂O₃ is used as the high refractive index material, similarly to a case where hafnium oxide HfO₂ is used as the high refractive index material, the reflectance is increased as the number of stacked layers is increased. As shown in FIGS. 2A-2B, in the dielectric multilayer film mirror in which hafnium oxide HfO₂ is used, when the number of stacked layers is increased up to 30 (15 pairs), the reflectance reaches the upper limit (99.67%). However, in the dielectric multilayer film mirror in which aluminum oxide Al₂O₃ is used, when the number of stacked layers is increased up to 70 (35 pairs), the reflectance is increased and reaches the upper limit (99.80%).

Since the aluminum oxide Al₂O₃ has an extinction coefficient of 250 nm smaller than that of the hafnium oxide HfO₂, the reflectance continues to increase until the number of stacked layers is larger than that in the case where the hafnium oxide HfO₂ is used. However, the refractive index of the aluminum oxide Al₂O₃ is 1.68 (@250 nm), which is smaller than the refractive index of the hafnium oxide HfO₂ of 2.18 (@250 nm). Accordingly, a difference in refractive index between the aluminum oxide Al₂O₃ and the silicon oxide SiO₂ is small as compared to the dielectric multilayer film mirror in which the hafnium oxide HfO₂ is used as the high refractive index material. Therefore, in the dielectric multilayer film mirror in which the aluminum oxide Al₂O₃ is used, 70 layers (35 pairs) are required to be stacked in order to increase the reflectance up to the upper limit. In the dielectric multilayer film mirror in which the aluminum oxide Al₂O₃ is used, the maximum reflectance is higher than the maximum reflectance (99.67%) of the dielectric multilayer film mirror in which the hafnium oxide HfO₂ is used, but it takes a lot of time to produce the dielectric multilayer film due to an increase of the number of stacked layers, and the cost also increases.

After the above examination, the present inventors have found that the loss of the amount of light due to light absorption is suppressed by disposing aluminum oxide Al₂O₃ (that is, used as the second high refractive index material) having a small extinction coefficient at 250 nm in a region where the amount of incident light is large, and a reflection efficiency is increased at the interface between hafnium oxide HfO₂ and silicon oxide SiO₂ by disposing the hafnium oxide HfO₂ (that is, used as the first high refractive index material) having a high refractive index in a region where the amount of incident light is relatively small.

As illustrated in FIG. 4, according to the simulation (wavelength of 250 nm) performed by the present inventors, in the dielectric multilayer film mirror including alternately stacked layers of aluminum oxide Al₂O₃ and silicon oxide SiO₂, 14% of the incident light is reflected at 2 layers (1 pair) positioned at the outermost surface, 23% of the incident light is reflected at 4 layers (2 pairs) (that is, 9% of the incident light is reflected by adding a third layer and a fourth layer), and 32% of the incident light is reflected at 6 layers (3 pairs) (that is, 9% of the incident light is reflected by adding a fifth layer and a sixth layer). That is, since the incident light is mostly reflected at a small number of layers positioned at the outermost surface, the amount of light that reaches a layer located deeper than the layers positioned at the outermost surface and is absorbed in the deep layer is not large. Therefore, the present inventors have reached the conclusion that it is possible to produce a dielectric multilayer film mirror having a high reflectance with low costs by adopting a configuration in which a multilayer film structure including alternately stacked layers of aluminum oxide Al₂O₃ and silicon oxide SiO₂ is disposed near a surface of the dielectric multilayer film mirror, and a multilayer film structure including alternately stacked layers of hafnium oxide HfO₂ and silicon oxide SiO₂ is disposed near the substrate (deep layer side).

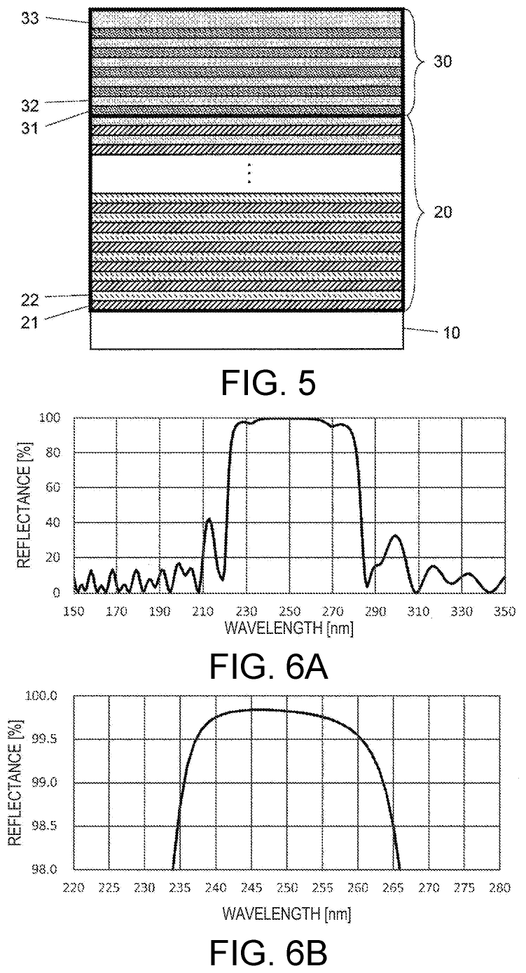

FIG. 5 is a view showing a configuration of a dielectric multilayer film mirror of one embodiment according to the present invention. The dielectric multilayer film mirror of the present embodiment generally includes a substrate 10, a first multilayer film structure 20 formed on the substrate 10, and a second multilayer film structure 30 formed on the first multilayer film structure 20. The first multilayer film structure 20 is a structure including alternately stacked first low refractive index material layers 22 and first high refractive index material layers 21. The second multilayer film structure 30 is a structure including alternately stacked second low refractive index material layers 32 and second high refractive index material layers 31.

Since the second multilayer film structure 30 is disposed near a surface of the mirror where the amount of incident light is large, based on the above consideration, aluminum oxide Al₂O₃ having an extinction coefficient lower than that of hafnium oxide HfO₂ is used for the second high refractive index material layer 31. The second low refractive index material layer 32 is formed of silicon oxide SiO₂ similarly to the related art. Therefore, an amount of absorbed light is suppressed and an amount of incident light is mostly reflected. The outermost layer of the second multilayer film structure 30 also serves as a protective layer 33 for preventing damage of the surface of the mirror. In the present embodiment, the protective layer 33 is formed of silicon oxide SiO₂ similarly to the second low refractive index material layer 32 at a thickness twice that of each of the first low refractive index material layer 22 and the second low refractive index material layer 32 (silicon oxide) in the first multilayer film structure 20 and the second multilayer film structure 30. The second high refractive index material layer 31 (aluminum oxide Al₂O₃) that is positioned adjacent to the protective layer 33 and is used in the second multilayer film structure 30 may also be used for the protective layer 33. However, in the present embodiment, silicon oxide SiO₂ having a further excellent environment resistance is used. In addition, in the present embodiment, a thickness of the protective layer 33 is set to be twice that of each of other layers (that is, an optical thickness is 212). The optical thickness of the protective layer 33 may be an integral multiple of 212, and is not necessarily limited to 212.

On the other hand, since the first multilayer film structure 20 is disposed at a deep layer portion where the amount of incident light is small, based on the above consideration, hafnium oxide HfO₂ having a refractive index higher than that of aluminum oxide Al₂O₃ is used for the first high refractive index material layer 21. The first low refractive index material layer 22 is formed of silicon oxide SiO₂ similarly to the second low refractive index material layer 32 used in the second multilayer film structure 30. Therefore, in the first multilayer film structure 20, a difference in refractive index between the high refractive index material and the low refractive index material is large as compared to that in the second multilayer film structure 30, and thus the light passed through the second multilayer film structure 30 is efficiently reflected. In the present embodiment, although both the first low refractive index material layer 22 and the second low refractive index material layer 32 are formed of silicon oxide SiO₂, a material having a refractive index lower than that of the second low refractive index material layer 32 is used for the first low refractive index material layer 22, so that the difference in refractive index can be further increased.

In the configuration shown in FIG. 5, when the number of stacked layers in the first multilayer film structure 20 is 30 (15 pairs), and the number of stacked layers in the second multilayer film structure 30 is 10 (5 pairs), as shown in FIGS. 6A-6B, the high reflectance of 99.82% of ultraviolet light of 250 nm can be obtained. This reflectance is higher than both the maximum reflectance (99.67%) of the dielectric multilayer film mirror obtained by stacking 40 layers (20 pairs) formed of hafnium oxide HfO₂ and silicon oxide SiO₂, and the maximum reflectance (99.80%) of the dielectric multilayer film mirror obtained by stacking 70 layers (35 pairs) formed of aluminum oxide Al₂O₃ and silicon oxide SiO₂. Materials and physical thicknesses of the respective layers constituting the dielectric multilayer film mirror of the present embodiment are shown in the following table.

TABLE 1

| | | Refractive index | Physical thickness |
|---|---|---|---|
| Layer No. | Material | (@250 nm) | (nm) |
| Incident medium | Air | 1.00 | |
| 40 | SiO₂ | 1.49 | 83.98 |
| 39 | Al₂O₃ | 1.68 | 37.11 |
| 38 | SiO₂ | 1.49 | 41.99 |
| 37 | Al₂O₃ | 1.68 | 37.11 |
| 36 | SiO₂ | 1.49 | 41.99 |
| 35 | Al₂O₃ | 1.68 | 37.11 |
| 34 | SiO₂ | 1.49 | 41.99 |
| 33 | Al₂O₃ | 1.68 | 37.11 |
| 32 | SiO₂ | 1.49 | 41.99 |
| 31 | Al₂O₃ | 1.68 | 37.11 |
| 30 | SiO₂ | 1.49 | 41.99 |
| 29 | HfO₂ | 2.18 | 28.64 |
| 28 | SiO₂ | 1.49 | 41.99 |
| 27 | HfO₂ | 2.18 | 28.64 |
| 26 | SiO₂ | 1.49 | 41.99 |
| 25 | HfO₂ | 2.18 | 28.64 |
| 24 | SiO₂ | 1.49 | 41.99 |
| 23 | HfO₂ | 2.18 | 28.64 |
| 22 | SiO₂ | 1.49 | 41.99 |
| 21 | HfO₂ | 2.18 | 28.64 |
| 20 | SiO₂ | 1.49 | 41.99 |
| 19 | HfO₂ | 2.18 | 28.64 |
| 18 | SiO₂ | 1.49 | 41.99 |
| 17 | HfO₂ | 2.18 | 28.64 |
| 16 | SiO₂ | 1.49 | 41.99 |
| 15 | HfO₂ | 2.18 | 28.64 |
| 14 | SiO₂ | 1.49 | 41.99 |
| 13 | HfO₂ | 2.18 | 28.64 |
| 12 | SiO₂ | 1.49 | 41.99 |
| 11 | HfO₂ | 2.18 | 28.64 |
| 10 | SiO₂ | 1.49 | 41.99 |
| 9 | HfO₂ | 2.18 | 28.64 |
| 8 | SiO₂ | 1.49 | 41.99 |
| 7 | HfO₂ | 2.18 | 28.64 |
| 6 | SiO₂ | 1.49 | 41.99 |
| 5 | HfO₂ | 2.18 | 28.64 |
| 4 | SiO₂ | 1.49 | 41.99 |
| 3 | HfO₂ | 2.18 | 28.64 |
| 2 | SiO₂ | 1.49 | 41.99 |
| 1 | HfO₂ | 2.18 | 28.64 |
| Substrate | Synthetic | 1.51 | |
| | quartz | | |
| | | | Total thickness: |
| | | | 1496.94 |

A physical thickness of each of the layers in the first multilayer film structure 20 and the second multilayer film structure 30 is set such that the product of the physical thickness and the refractive index becomes a quarter of a desired wavelength (in the present embodiment, 250 nm). That is, in the first multilayer film structure 20, a physical thickness of the first low refractive index material layer 22 (silicon oxide) is 41.99 nm, and a physical thickness of the first high refractive index material layer 21 (hafnium oxide) is 28.64 nm. In the second multilayer film structure 30, a physical thickness of the second low refractive index material layer 32 (silicon oxide) is 41.99 nm, and a physical thickness of the second high refractive index material layer 31 (aluminum oxide) is 37.11 nm. A physical thickness of the protective layer 33 positioned at the outermost surface is 83.98 nm.

An optical path difference of a half wavelength (λ/4+λ/4) is generated in the light reflected at each interface between layers stacked at an optical thickness of a quarter wavelength λ (λ/4) of the incident light. In addition, a phase of light that is incident from a low refractive index layer and is reflected at the interface between the low refractive index layer and a high refractive index layer is inverted at the time of reflection (the same effect as in the generation of the optical path difference of 212). On the other hand, a phase of light that is incident from the high refractive index layer and is reflected at the interface between the low refractive index layer and the high refractive index layer is not inverted. As a result, the phases of the light reflected at each interface between the high refractive index layers and the low refractive index layers are aligned (optical path difference λ/2+effect 212 obtained by phase inversion effect=λ).

As described above, in the dielectric multilayer film mirror of the present embodiment, a higher reflectance (99.82%) is obtained as compared to both the upper limit (99.67%) of the reflectance of the conventional multilayer film mirror including alternately stacked layers of hafnium oxide HfO₂ and silicon oxide SiO₂ and the upper limit (99.80%) of the reflectance of the conventional dielectric multilayer film mirror including alternately stacked layers of aluminum oxide Al₂O₃ and silicon oxide SiO₂. In addition, in the dielectric multilayer film mirror including alternately stacked layers of aluminum oxide Al₂O₃ and silicon oxide SiO₂, 70 layers (35 pairs) are required to be stacked in order to obtain an upper limit value of the reflectance. On the other hand, in the dielectric multilayer film mirror of the present embodiment, the total number of layers in the first multilayer film structure 20 and the second multilayer film structure 30 is reduced to 40 (20 pairs), and thus the dielectric multilayer film mirror can be easily produced with low costs. The reflectance obtained when the number of layers of aluminum oxide Al₂O₃ and silicon oxide SiO₂ is the same as in the present embodiment, that is, a total of 40 layers (20 pairs) are stacked is 98.17%. In the dielectric multilayer film mirror of the present embodiment, a sufficiently higher reflectance is obtained.

The embodiment is merely an example and can be appropriately changed within the spirit of the present invention. In the embodiment, although the number of stacked layers in the first multilayer film structure 20 is 30 (15 pairs) and the number of stacked layers in the second multilayer film structure 30 is 10 (5 pairs), the number of stacked layers can be appropriately changed in consideration of a balance between a level of the reflectance to be obtained and the cost. For example, in a case where the cost is reduced (that is, the number of stacked layers is reduced) with the same reflectance as in the related art, the number of stacked layers in the first multilayer film structure 20 may be 18 (9 pairs), and the number of stacked layers in the second multilayer film structure 30 may be 8 (4 pairs) (reflectance: 99.68%). Alternatively, in a case where the same number of stacked layers (70 layers) as in the conventional dielectric multilayer film mirror including alternately stacked layers of aluminum oxide Al₂O₃ and silicon oxide SiO₂ is allowable, when the number of stacked layers in the first multilayer film structure 20 is 22 (11 pairs), and the number of stacked layers in the second multilayer film structure 30 is 48 (24 pairs), a high reflectance of 99.84% is obtained.

In addition, in the embodiment, silicon oxide is used as the first low refractive index material and the second low refractive index material, hafnium oxide is used as the first high refractive index material, and aluminum oxide is used as the second high refractive index material, but the present invention is not necessarily limited to only this combination. As described above, an appropriate material having a refractive index equal to or lower than that of the second low refractive index material can be used as the first low refractive index material, an appropriate material having a refractive index higher than that of the first low refractive index material can be used as the first high refractive index material, and an appropriate material having a refractive index higher than that of silicon oxide and having an extinction coefficient lower than that of the first high refractive index material can be used as the second high refractive index material.

### REFERENCE SIGNS LIST

10 . . . Substrate
20 . . . First Multilayer Film Structure
21 . . . First High Refractive Index Material Layer
22 . . . First Low Refractive Index Material Layer
30 . . . Second Multilayer Film Structure
31 . . . Second High Refractive Index Material Layer
32 . . . Second Low Refractive Index Material Layer
33 . . . Protective Layer

1. A dielectric multilayer film mirror comprising:
a substrate;
a first multilayer film structure formed on the substrate including alternately stacked layers of a first low refractive index material and a first high refractive index material, the first low refractive index material having a refractive index equal to or lower than a refractive index of a second low refractive index material, and the first high refractive index material having a refractive index higher than refractive indices of the first low refractive index material and a second high refractive index material; and
a second multilayer film structure formed on the first multilayer film structure including alternately stacked layers of the second low refractive index material and the second high refractive index material, the second high refractive index material having a refractive index higher than a refractive index of the second low refractive index material and having an extinction coefficient lower than an extinction coefficient of the first high refractive index material.

2. The dielectric multilayer film mirror according to claim 1, wherein the first low refractive index material and the second low refractive index material are silicon oxide.

3. The dielectric multilayer film mirror according to claim 1, wherein the first high refractive index material is hafnium oxide.

4. The dielectric multilayer film mirror according to claim 1, wherein the second high refractive index material is aluminum oxide.

5. The dielectric multilayer film mirror according to claim 1, further comprising:
a protective layer formed on the second multilayer film structure and formed of a material which is one of the second low refractive index material and the second high refractive index material that is different from a material disposed on an outermost surface of the second multilayer film structure.

6. The dielectric multilayer film mirror according to claim 5, wherein an optical thickness of the protective layer is an integral multiple of λ/2 of a desired wavelength λ.

7. The dielectric multilayer film mirror according to claim 1, wherein a number of stacked layers in the second multilayer film structure is equal to or more than 8 and equal to or less than 48.

8. The dielectric multilayer film mirror according to claim 1, wherein a total of a number of stacked layers in the second multilayer film structure and a number of stacked layers in the first multilayer film structure is equal to or more than 26 and equal to or less than 70.
